(19) United States
(12) Patent Application Publication
(10) Pub. No.: US 2002/0118817 A1
(43) Pub. Date: Aug. 29, 2002

(54) Repeating device

(76) Inventor: Waichi Horiuchi, Tokyo (JP)

Correspondence Address: JAY H. MAIOLI, Cooper & Dunham LLP, 1185 Avenue of the Americas, New York, NY, 10036, US

(21) Appl. No.: 09/795,869

(22) Filed: Feb. 28, 2001

(51) Int. Cl. H04M 1/00; H04M 9/00

(52) U.S. Cl. 379/338; 379/387.01

(57) ABSTRACT

Aincludes a connection terminal unit capable of connecting a telephone, a handset and a headset, a connection path selection switch capable of selecting a connection path depending upon the kinds of the telephone and the handset, and an audible signal generator which gives required information when a wiring is established by the connection terminal unit adapted to the telephone and to the handset by the connection path selection switch. Further, the connections of insulated conductors between the telephone and the handset are successively cut to search a state of connection where no voice is heard from the telephone.

### BACKGROUND OF THE INVENTION

1. Field of the Invention

The present invention relates to a used for connecting devices such as a handset as well as a headset to, for example, a telephone.

2 Prior Art

Of late telephones are now using a headset for carrying out a telephone conversation by being mounted on the head of a person who speaks in addition to using a handset.

FIG. 18 is a schematic diagram illustrating an example of when a handset and a headset are connected to a telephone.

A telephone 50 is connected to a public circuit that is not shown, and sending speech signals and receiving speech signals are sent to, or received from, another telephone through the public circuit. A handset 51 is produced by the same manufacturer and is of the same model as the telephone 50, and includes a speaker unit 51a for producing receiving speech signals from the telephone 50 and a microphone unit 51b for sending speech signals to the telephone 50. Here, these devices are regarded to constitute a pair when both the telephone 50 and the handset 51 are produced by the same manufacturer and are of the same model, having the same connection specifications.

Like the handset 51, further, the headset 52 includes a speaker unit 52a for producing receiving speech signals from the telephone 50 and a microphone unit 52b for sending speech signals to the telephone 50.

Usually, the telephone 50 and the handset 51 are directly connected together through a wire formed of plural insulated conductors. In the example shown in FIG. 18, however, since the headset 52 is used, a headset adaptor 60 which is a repeating deviceÅ@ is connected. Namely, the handset 51 and the headset 52 are connected to the telephone 50 through the headset adaptor 60.

As required, therefore, a selection switch provided in the headset adaptor 60 is changed over to make a speech by selecting the handset 51 or the headset 52.

FIG. 19 shows external devices that can be connected to the telephone 50.

FIG. 19(a) illustrates an example in which a speech recording adaptor 61 is arranged between the telephone 50 and the handset 51 to connect a tape recorder 66 for recording speech voice. In this case, the content of a speech can be recorded by the tape recorder 66, and the content of the speech can be heard again even after the speech has been finished.

FIG. 19(b) illustrates an example in which a speech loudspeaker device 70 is disposed as a repeating device to produce the speech voice from a speaker 71 which is an external device. Therefore, plural users are allowed to listen to the content of the speech at one time.

FIG. 19(c) illustrates an example in which a receiving speech volume amplifier 72 is arranged as a repeating device, whereby amplified receiving voice signals are input to the handset 51 and are outputted in a large sound volume. Therefore, the user is allowed to listen to the content of a speech in a large sound volume by using a handset.

Further, though not illustrated, other examples of the repeating device may be a speaker telephone for adding a speaker telephone function to the telephone which does not have the speaker telephone function, and a converter device for converting voice signals into character data so that a deaf-and-dumb person is allowed to make a speech by using the telephone.

Or, a repeating device is often arranged when it is not allowed to connect a modem device directly to a telephone circuit such as business telephone.

Here, the telephone 50, handset 51, repeating devices (headset adaptor 60, speech recording adaptor 61, speech loudspeaker device 70, receiving volume amplifier 72) and external devices (headset 52, tape recorder 66, speaker 71) can be connected by using their dedicated connection codes (wire members). These connection codes have plural insulated conductors that are shielded, some of the insulated conductors being used for sending a speech or for receiving a speech. If now the handset 51 is considered, two insulated conductors among the four are used for the speaker unit 51a and the remaining two conductors are used for the microphone unit 51b.

In this case, if the telephone 50 and the handset 51 are constituted as a pair as described above, the combination of sending the speech/receiving the speech through the insulated conductors can be corresponded thereto. However, the telephone 50 and the external devices are not necessarily produced by the same manufacturer in the same connection specifications, and the combinations of the insulated conductors are not necessarily the same. It therefore becomes necessary to select the state of wiring in the repeating device.

FIG. 20 illustrates the constitution of the speech recording adaptor 61 shown in FIG. 19(a). The speech recording adaptor 61 includes a terminal 62 connected to the telephone 50, a terminal 63 connected to the handset 51, and a terminal 64 connected to the tape recorder 66. As described above, if the telephone 50 and the handset 51 form a pair, the insulated conductors L3, L1, L2 and L4 correspond to for-speech-sending /for-speech-receiving. For example, if it is presumed that the insulated conductors L1 and L2 are wirings corresponding to for-speech-receiving, the insulated conductors L1 and L2 of the handset 51 are those corresponding to the speaker unit 51b. In this case, the insulated conductors L3 and L4 are wirings corresponding to for-speech-sending.

Therefore, there is no need of changing over the state of connection of the insulated conductors (1 to 4) in the speech recording adaptor 61.

When the tape recorder 66 which is the external device is used, however, the switch 65 is changed over to detect that the insulated conductors L1 and L2 are for reception and the insulated conductors L3 and L4 are for sending, and the connection must be such that the signals through the insulated conductors L1 and L2 are fed to the tape recorder 66 for recording and the signals through the insulated conductors L3 and L4 are fed to the tape recorder 66 for play back. That is, if the insulated conductor L11 is for recording and the insulated conductor L12 is for play back, it cannot be said that the telephone 50 and the tape recorder 66 are properly connected unless the insulated conductors L1 and L2 are made to correspond to the insulated conductor L11, and the insulated conductors L3 and L4 are made to correspond to the insulated conductor L12 by changing over the switch 65.

It is therefore desired to constitute a repeating device capable of easily and efficiently obtaining an optimum insulated conductor connection condition between the telephone 50 and the external device.

### SUMMARY OF THE INVENTION

In order to solve the above-mentioned problems, therefore, the present invention provides a repeating device having first and second connection terminal units for connecting a telephone and a handset together through a wire member having plural insulated conductors, and for relaying the connection between said telephone and said handset, said repeating device comprising:

a third connection terminal unit for connection to an external unit through a wire member having plural insulated conductors;

connection path selection means capable of selecting a connection path of said insulated conductors depending upon the kinds of the telephone and the handset; and

informing means for giving a required information when the wiring of said third connection terminal unit becomes the connection path of said insulated conductors corresponding to said telephone and said handset due to the selection by said connection path selection means.

The invention further provides a repeating device having first and second connection terminal units for connecting a telephone and a handset together through a wire member having plural insulated conductors, and for relaying the connection between said telephone and said handset, said repeating device comprising:

a third connection terminal unit for connection to an external unit through a wire member having plural insulated conductors; and

connection path selection means for successively cutting the connection of the insulated conductors connecting said telephone to said handset.

The present invention makes it possible to easily and efficiently connect the telephone with the external device by finding out correct wirings.

### BRIEF DESCRIPTION OF THE DRAWINGS

FIG. 1 is a diagram illustrating the constitution of a repeating device according to a first embodiment of the present invention;

FIG. 2 is a diagram illustrating a connection path using the repeating device according to the first embodiment;

FIG. 3 is a diagram illustrating the connection path using the repeating device according to the first embodiment;

FIG. 4 is a diagram illustrating wirings selected depending upon the state of connection of the repeating device according to the first embodiment;

FIG. 5 is a diagram illustrating the constitution of a modified example of the repeating device according to the first embodiment;

FIG. 6 is a diagram illustrating a connection path of the modified example of the repeating device according to the first embodiment;

FIG. 7 is a diagram illustrating a connection path of the modified example of the repeating device according to the first embodiment;

FIG. 8 is a diagram illustrating the wirings selected depending upon the state of connection of the modified example of the repeating device according to the first embodiment;

FIG. 9 is a diagram illustrating the constitution of a repeating device according to a second embodiment of the present invention;

FIG. 10 is a diagram schematically illustrating a connection path selected by the repeating device according to the second embodiment;

FIG. 11 is a diagram illustrating a connection path using the repeating device according to the second embodiment;

FIG. 12 is a diagram illustrating a connection path using the repeating device according to the second embodiment;

FIG. 13 is a perspective view illustrating the appearance of the repeating device according to the present invention;

FIG. 14 is a perspective view illustrating the appearance of another repeating device according to the present invention;

FIG. 15 is a diagram illustrating combinations of wirings of a speaker unit and a microphone unit in a handset;

FIG. 16 is a diagram illustrating connection patterns of a switch;

FIG. 17 is a diagram illustrating connection patterns of a switch;

FIG. 18 is a diagram illustrating a handset and a headset connected to a telephone via a headset adaptor which is a repeating device;

FIG. 19 is a diagram illustrating other examples of the repeating device; and

FIG. 20 is a diagram illustrating the constitution of a speech recording adaptor shown in FIG. 19.

### DESCRIPTION OF THE PREFERRED EMBODIMENTS

Embodiments of the repeating deviceof the present invention will now be described in the following order.

1. A first embodiment.

2. A modified example of the first embodiment.

3. A second embodiment.

1. A first Embodiment.

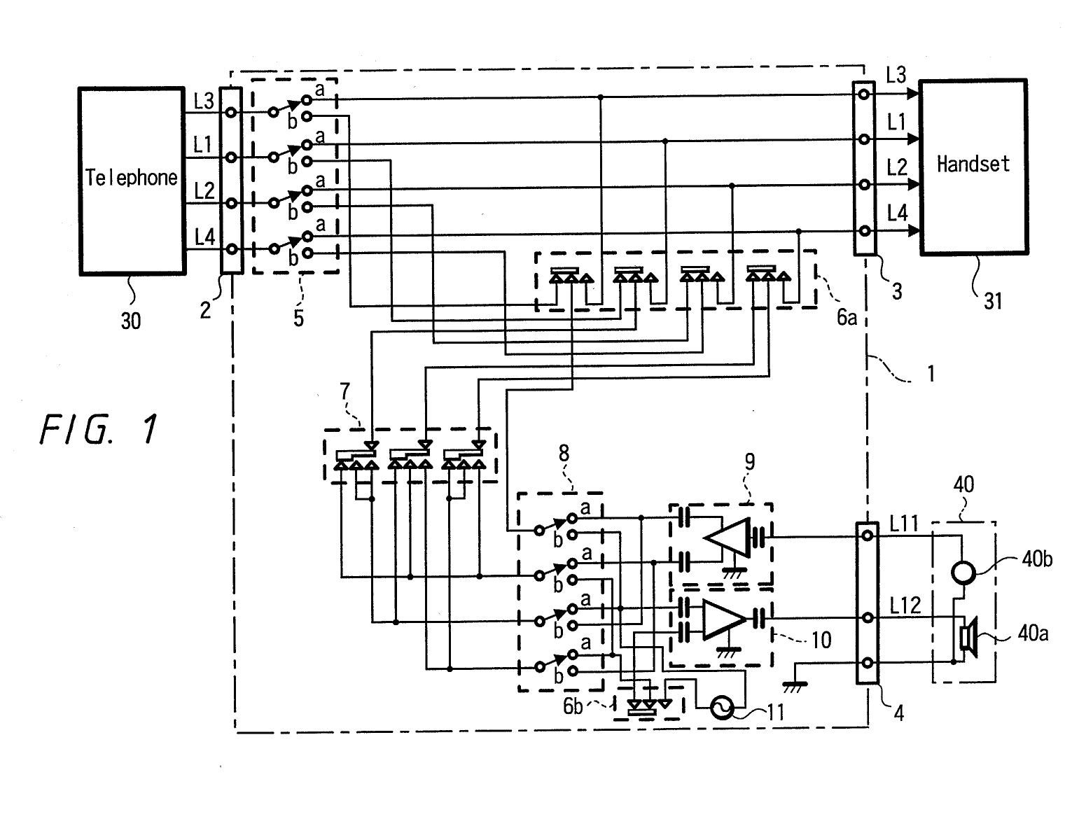

FIG. 1 is a diagram illustrating the constitution of a repeating device1 according to a first embodiment.

The repeating device1 includes a terminal 2 which is a first connection terminal unit, a terminal 3 which is a second connection terminal unit, and a terminal 4 which is a third connection terminal unit. To these terminals are connected a telephone 30, a handset 31, and a headset 40 which is an external device. The telephone 30 and the handset 31 are connected together through a connection cable formed of at least insulated conductors L1, L2, L3 and L4. The headset 40 is connected through a connection cable formed of at least insulated conductors L11 and L12.

The repeating device1 includes a connection selection switch 5 which selectively connects the telephone to either the handset 31 or the headset 40. When connection points a, a, a, a are selected in the connection selection switch 5, the handset 31 is selected and when connection points b, b, b, b are selected, the head set 40 is selected.

When the connection of the telephone 30 with the headset 40 is selected by the connection selection switch 5, connection path selection switches 7 and 8 in the repeating devicework to select a connection path between the telephone 30 and the headset 40.

Here, the connection path employed to pair the telephone 30 with the handset 40 can be realized in, for example, six different combinations as shown in FIGS. 15(a), 15(b), 15(c), 15(d), 15(e) and 15(f). These combinations are such that the insulated conductors L3 and L1 are connected to the microphone unit and the insulated conductors L2 and L4 are connected to the speaker unit in the case of FIG. 15(a), and that the insulated conductors L3 and L4 are connected to the microphone unit and the insulated conductors L1 and L2 are connected to the speaker unit in the case of FIG. 15(c).

When an external device is connected, therefore, a path for the external device must be formed out of these six combinations depending upon the connection path employed to pair the telephone 30 with the handset 31. Therefore, the connection path selection switches 7 and 8 must be successively changed over, so that the same wiring as the one for the handset 31 is employed even for the external unit.

In the example shown in FIG. 1, if now the wiring of FIG. 15(a) is employed to pair the telephone 30 with the handset 31, then, the insulated conductors L3 and L1 may be made to correspond to the insulated conductor L11, and the insulated conductors L2 and L4 may be made to correspond to the insulated conductor L12 by the connection path selection switches 7 and 8.

Then, the telephone 30 and the headset 40 are correctly connected together, and the headset 40 can be used like the handset 31.

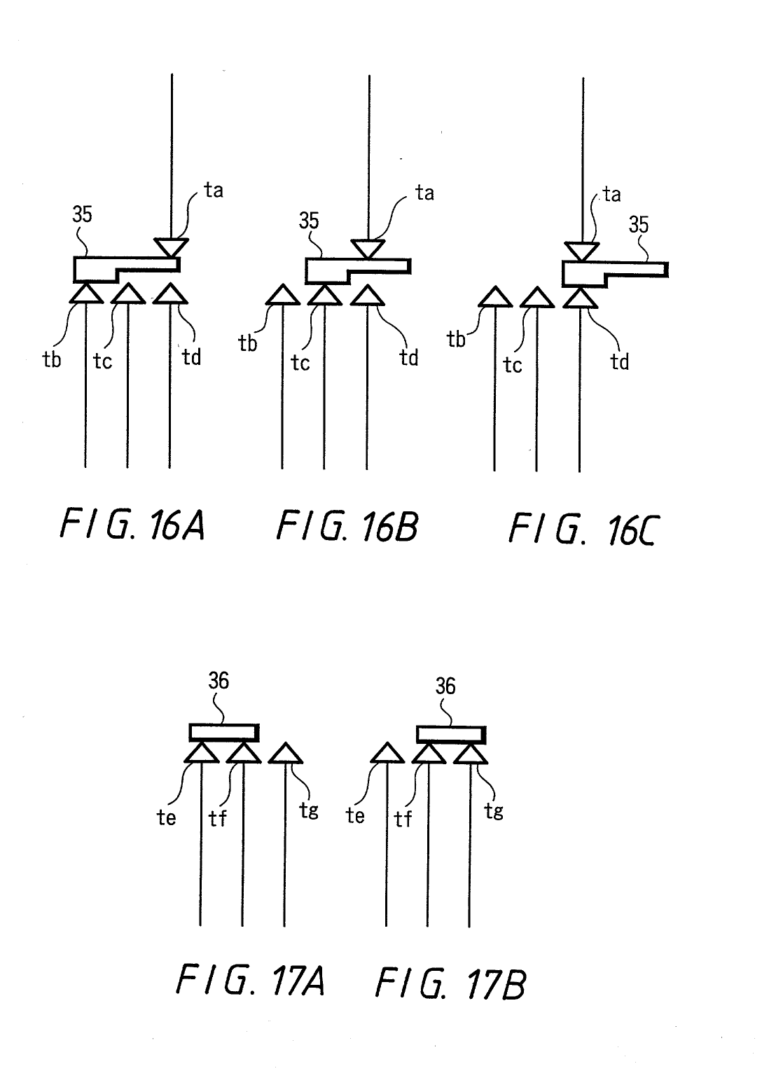

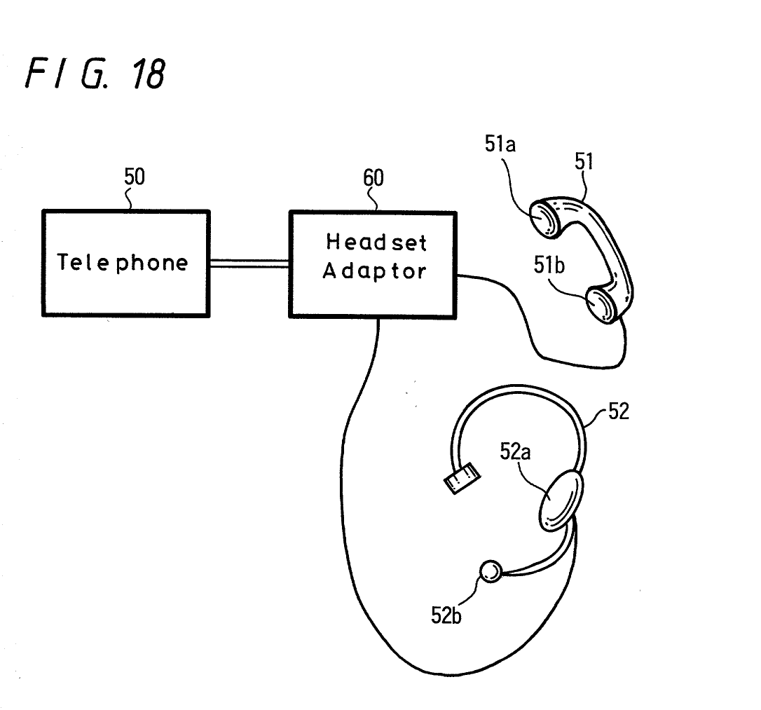

The connection path selection switch 7 is constituted, for example, as a slide switch having three contacts, and is connected in a manner as shown on an enlarged scale in FIGS. 16(a), 16(b) and 16(c).

In these drawings, a contact ta on the side of the telephone 30 is connected, via a conductor 35, to any one of a contact tb on the side of the headset 40 as shown in FIG. 16(a), a contact tc as shown in FIG. 16(b) or a contact td as shown in FIG. 16(c). That is, the connection path selection switch 7 selects three kinds of connection states. In the example shown in FIG. 1, however, three conductors 31 are interlocked for the three systems of insulated conductors L1, L2 and L4 of from the telephone 30.

In the following description of the repeating device1 with reference to the drawings, reference numerals of the contacts and conductors are not described, but are often described, as required, with reference to FIG. 16.

Test switches 6a and 6b which are slide switches having three contacts, work to select a state where the repeating device1 is normally used, i.e., a state where the telephone 30 stands by or is used for speech (hereinafter referred to as normal mode) or a state for selecting a connection between the telephone 30 and the headset 40 (hereinafter referred to as test mode) in a state where the headset 40 is being selected by the connection selection switch 5. In the diagramed example, the normal mode is selected, so that either the handset 3 or the headset 40 can be selected by the connection selection switch 5.

The connection of the test switches 6 (6a, 6b) will be described with reference to FIGS. 17(a) and 17(b).

FIG. 17(a) illustrates a state where contacts te and tf are connected together by a conductor 36, and FIG. 17(b) illustrates a state where contacts tf and tg are connected together by the conductor 36. That is, the test switch 6 works such that two contacts are connected together by the conductor 36 among the three contacts te, tf and tg. In the following description of the repeating device1, reference numerals of the contacts and conductors of the test switch 6 are not described, but are described, as required, with reference to FIG. 17.

Though the test switches 6 (6a, 6b) are separately diagramed for convenience, they are constituted as the same switch.

Amplifier units 9 and 10 surrounded by broken lines are made to correspond to the microphone unit 40b and the speaker unit 40a in the headset 40 to amplify voice signals. Therefore, the receiving speech voice can be heard in a suitable sound volume from the speaker unit 40a of the headset 40, and a sending speech voice from the microphone unit 40b is outputted to the telephone 30 in a suitable sound volume.

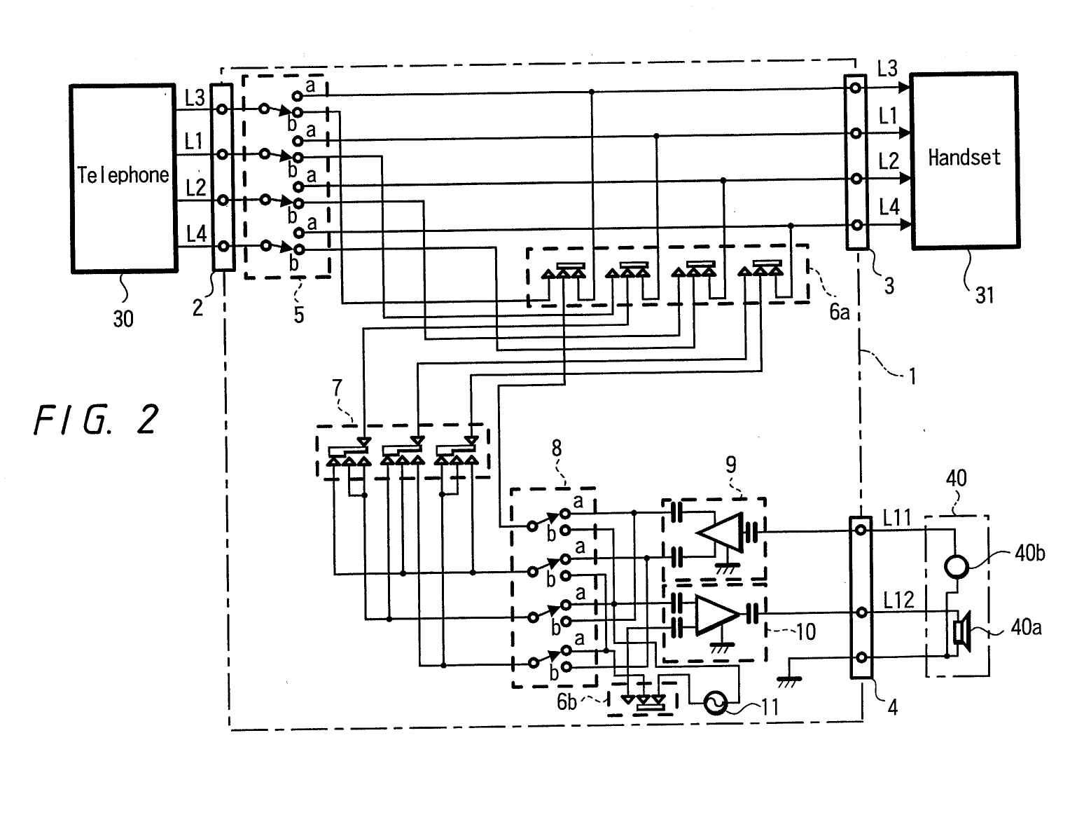

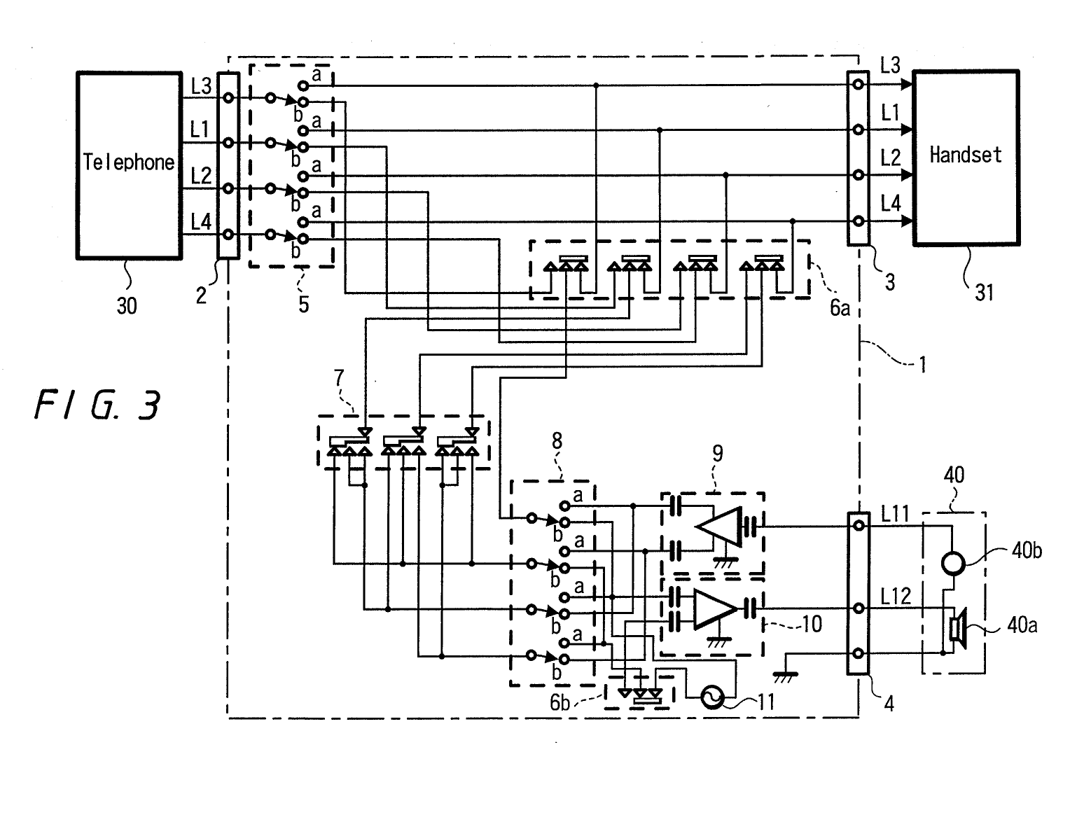

An audible signal generator 11 is constituted by, for example, an oscillator as informing means, and produces audible signals of about 400 Hz to 1 KHz as a dial tone. As will be described later with reference to FIGS. 2 and 3, a signal tone is outputted to the speaker of the handset 31 when the state of connection corresponding to the speaker unit 40a of the headset 40 is brought into agreement with the state of connection of the speaker (not shown) in the handset 31 by the connection path selection switches 7 and 8 in a state where the test mode is selected.

The audible signal generator 11 produces a signal tone by utilizing a power source (not shown) for the amplifiers 9, 10 in the repeating device1, and there is no need for newly adding the power source.

In the constitution shown in FIG. 1, the four connection paths between some of the contacts a or b in the connection path selection switch 8 and the amplifier units 9, 10, are made to correspond to the insulated conductors L (L1 to L4).

Knobs for selecting the connection of the diagramed switches are exposed on the operation unit formed at a desired position on the housing of the repeating devicethat will be described later.

FIGS. 2 and 3 are diagrams illustrating the connections of the switches in the test mode.

To search for a correct connection between the telephone 30 and the headset 40, the connection selection switch 5 is changed over toward the side of the contacts b as shown in FIG. 2, so that the headset 40 is selected, the test switch 6a is changed over as shown in FIG. 17(b) and the switch 6b is changed over as shown in FIG. 17(a), in order to change the mode over to the test mode. Then, the connection path selection switch 7 is successively changed over to the states shown in FIGS. 16(a), 16(b) and 16(c) to obtain a connection state shown in, for example, FIG. 2. Then, a position is searched at which the handset 31 is able to hear a signal tone outputted from the audible signal generator 11. In the state shown in FIG. 2, when a signal tone is heard at a certain position to which the switch is changed over while changing over the connection path selection switch 7, this connection state accomplished by the connection path selection switch 7 is a correctly connected path corresponding to the headset 40 in the repeating device1.

In the state shown in FIG. 2, further, when no signal tone is heard despite the connection path selection switch 3 is changed over in three ways, then, the connection path selection switch 7 is changed over in three ways in a state where the connection path selection switch 8 is changed over to the side of the contacts b as shown in FIG. 3. When the signal tone is heard while changing over the connection path selection switch 7, the connection state accomplished by the connection path selection switch 7 at that moment represents a correct connection path corresponding to the headset 40 in the repeating device1.

That is, six combinations of wirings shown in FIG. 15 are selected upon changing over the connection path selection switches 7 and 8, and a connection state in any one of the six combinations, which enables the signal tone to be heard, is regarded to be a correctly connected state that corresponds to the headset 40.

Further, the connection path selection switches 7 and 8 are capable of detecting the wirings of the handset 31 and of forming a correctly connected path for the headset 40, and share the constitution of the switches for detecting the wirings and for forming a correct connection path for the headset 40. That is, the connection path selection switches 7 and 8 offer an advantage of detecting the wirings while forming a correct connection path.

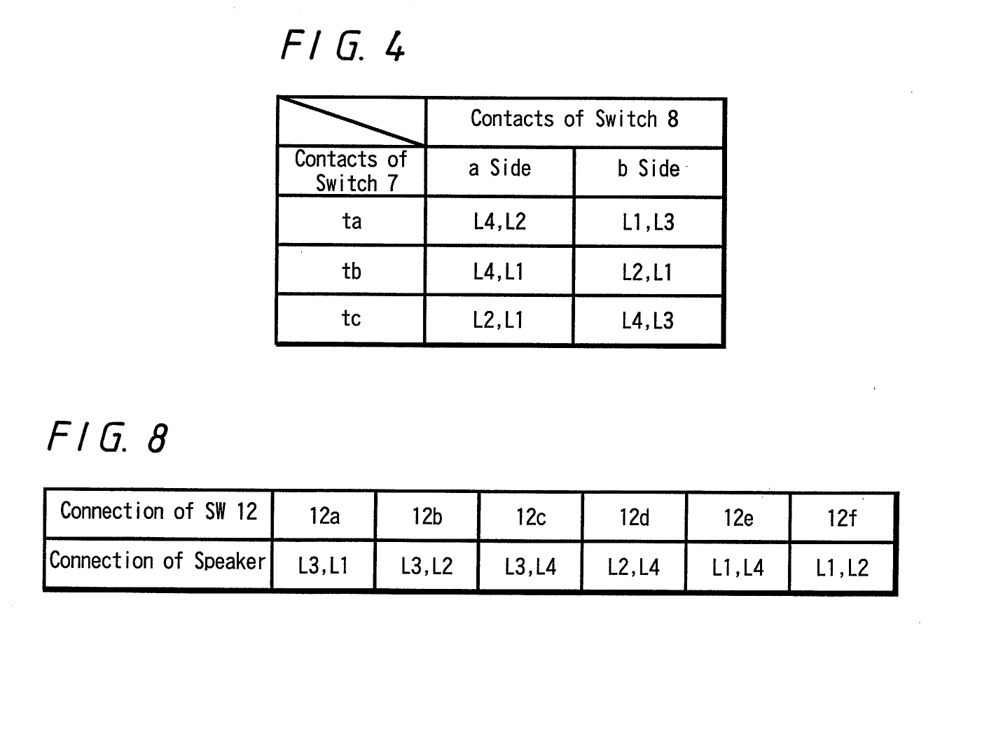

When the repeating device1 is constituted as shown in FIGS. 1, 2 and 3, the combinations of the insulated conductors L1 to L4 selected by the connection of the connection path selection switches 7, 8 become as shown in FIG. 4.

When, for example, the connection path selection switch 7 is on the side of the contact ta and the connection path selection switch 8 is on the side of the contacts a, the insulated conductors L4 and L2 are selected, and a connection path is formed for sending a signal tone from the audible signal generator 11 to the handset 31 through the insulated conductors L4 and L2. When the connection path selection switch 7 is on the side of the contact tc and the connection path selection switch 8 is on the side of the contacts b, the insulated conductors L4 and L3 are selected, and the signal tone is sent from the audible signal generator 11 to the handset 31 through the insulated conductors L4 and L3.

2. Modified Example of the First Embodiment.

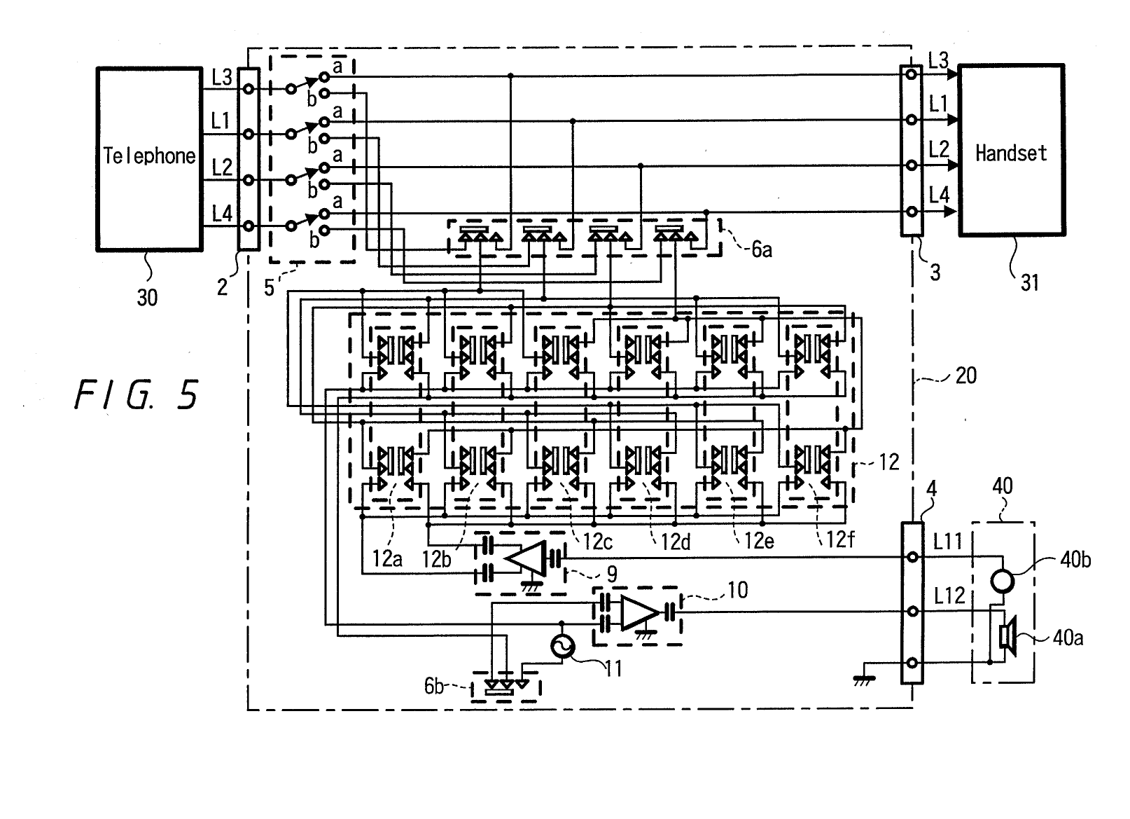

FIG. 5 illustrates a modified example of the first embodiment described with reference to FIGS. 1 to 4, and deals with the constitution of a repeating device 20 in which a connection path selection switch 12 is constituted by, for example, sextet interlocking push switch. The same portions as those of FIGS. 1 to 3 are denoted by the same reference numerals but are not described again.

The connection path selection switch 12 includes six repeating portions of from a repeating portion 12a up to a repeating portion 12f. Every time when a predetermined push switch (not shown) is manipulated, each of the repeating portion 12a to the repeating portion 12f is changed over one by one from the state shown in FIG. 17(a) over to the state shown in FIG. 17(b). That is, every time when the push switch is manipulated, the connection path selection switch 12 assumes a state in which any one of the repeating portions 12a to 12f is connected.

In the constitution shown in FIG. 5, the four connection paths between the connection path selection switch 12 and the amplifier units 9, 10 are made to correspond to the insulated conductors L (L1 to L4).

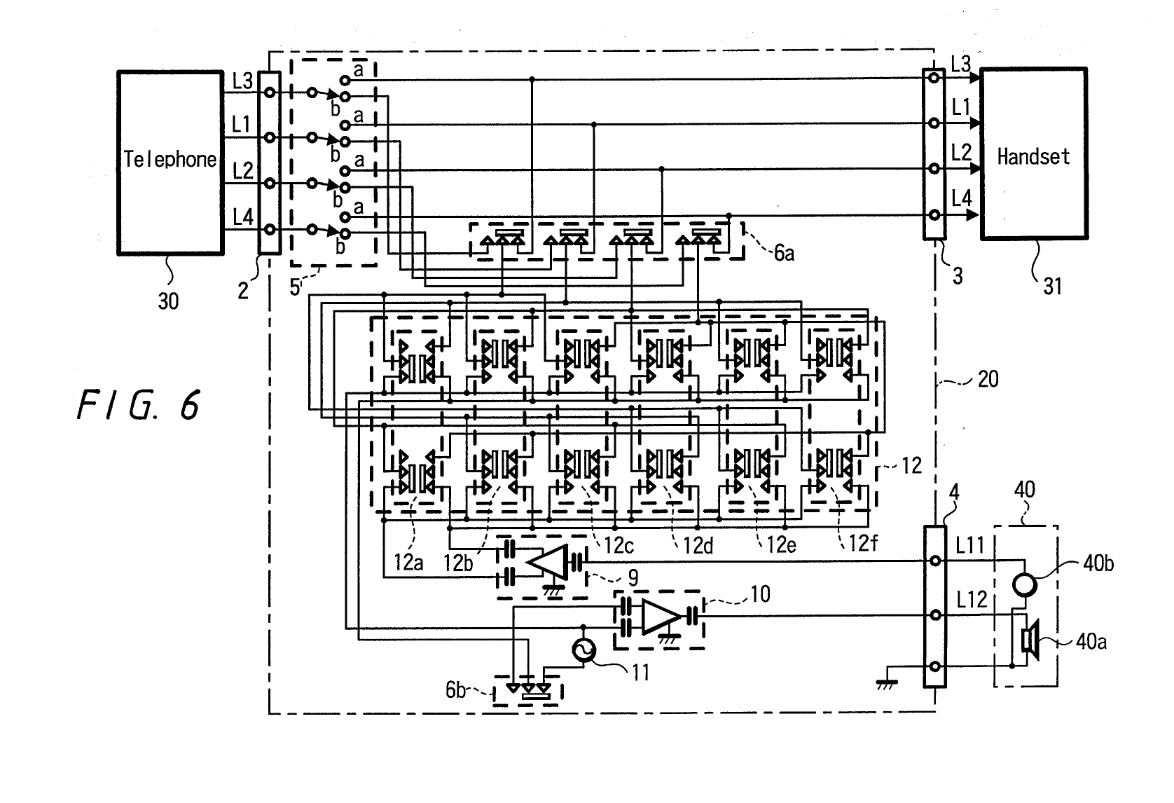

When the repeating device20 shown in FIG. 5 is to be changed over to the test mode, the connection selection switch 5 and the test switches 6 (6a, 6b) are changed over as shown in FIG. 6. Then, the connection path selection switch 12 is manipulated to successively change over the repeating portions 12a to 12f.

FIG. 6 illustrates a state in which the repeating portion 12a is connected in the test mode. When the signal tone is heard from the handset 31, in this case, the insulated conductors L3 and L1 are made to correspond to the insulated conductor L11, i.e., to the speaker unit 40a in the headset 40. In this case, further, the insulated conductors L4 and L2 correspond to the insulated conductor L12, i.e., to the microphone unit 40b in the headset 40. Thus, the telephone 30 and the headset 40 are correctly connected together.

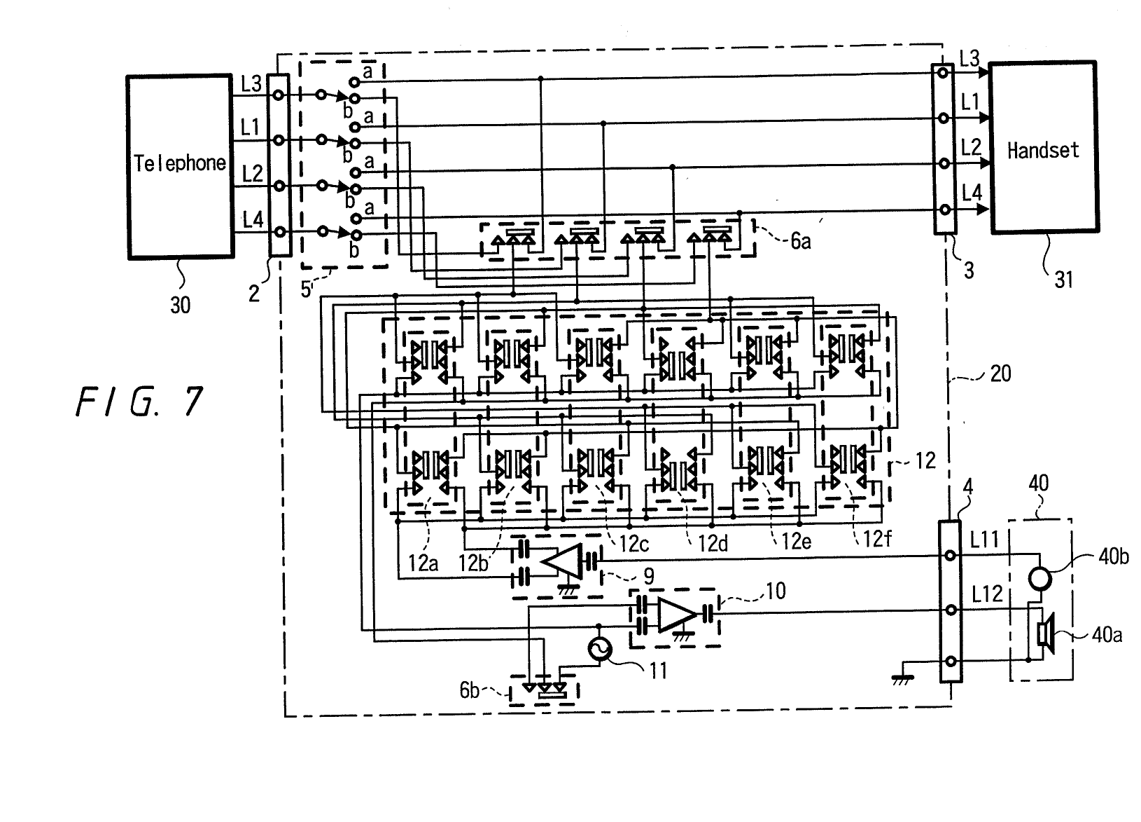

When no signal tone is heard in the state shown in FIG. 6, the connection selection switch 12 is further changed over. When the signal tone is heard in the state where the repeating portion 12d is connected as shown, for example, in FIG. 7, the insulated conductors L4 and L2 are corresponded to the insulated conductor L11 (speaker unit 40a of the headset 40), and the telephone 30 and the headset 40 are correctly connected together.

That is, as described with reference to FIGS. 6 and 7, six combinations of the wirings shown in FIG. 15 are selected upon successively changing over the connections of the repeating portion 12a up to the repeating portion 12f in the connection path selection switch 12. In any one of these six combinations, a connection state where the signal tone is heard can be regarded to be a correctly connected state where the telephone 30 and the headset 40 correspond to each other.

In the constitutions of the repeating device20 shown in FIGS. 5, 6 and 7, FIG. 8 illustrates the combinations of the insulated conductors L1 to L4 selected depending upon the connections of the repeating portions 12a to 12f in the connection path selection switch 12.

When, for example, the repeating portion 12a is connected as shown in FIG. 6, the insulated conductors L3 and L1 are selected, and the signal tone is outputted from the audible signal generator 11 to the handset 31 through the insulated conductors L3 and L1. When the repeating portion 12c is connected, further, the signal tone is outputted through the insulated conductors L3 and L4.

The connection path selection switch 12, too, shares the constitution of the switches for detecting the wirings and for forming a correct connection path for the headset 40, like the connection path selection switches 7 and 8.

According to the first embodiment and the modified example thereof as described above, it is regarded such that the telephone 30 and the headset 40 are properly connected together when the signal tone is heard from the handset while changing over the switches in the test mode. Even without knowing the wired state between the speaker unit 40a and the microphone unit 40b in the headset 40, therefore, the user may manipulate the switches to search for a state where he can hear the signal tone of the repeating device1 or 20 through the handset to thereby correctly connect the telephone 30 and the headset 40 together.

Besides, the audible signal generator 11 in the repeating device1 or 20 produces the signal tone. Therefore, the telephone and the headset can be correctly connected together even in a combination of plural connection patterns depending upon the connection paths in the repeating device 1, 20 and upon the type of the telephone, enabling the voice to be heard from the telephone.

The diagramed repeating devices 1 and 20 according to the first embodiment and the modified example thereof are only to explain the invention, and of which the constitutions of the switches and the wiring paths in the devices are in no way limited to the diagramed examples only.

3. A second Embodiment.

The repeating device according to a second embodiment described below is constituted such that the telephone is correctly connected to an external device such as the headset upon selecting a state where no voice (receiving speech sound or signal tone) is heard from the telephone through the handset.

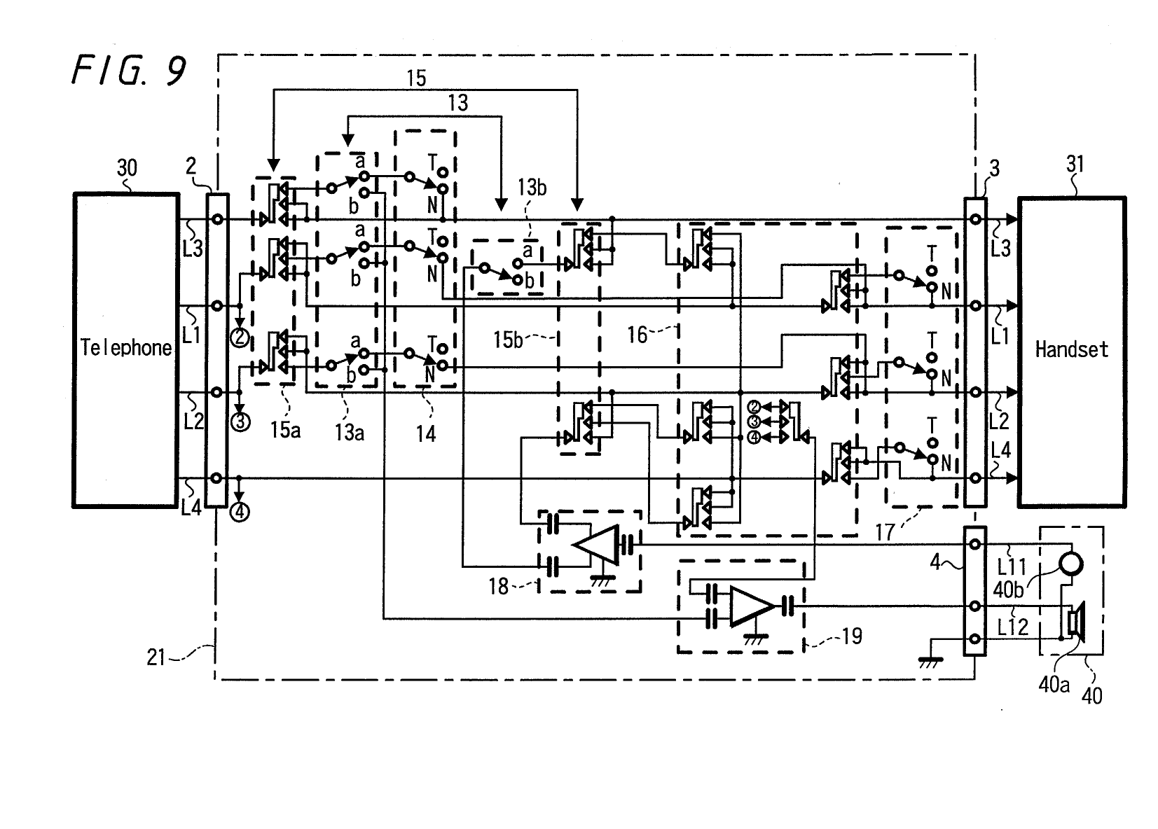

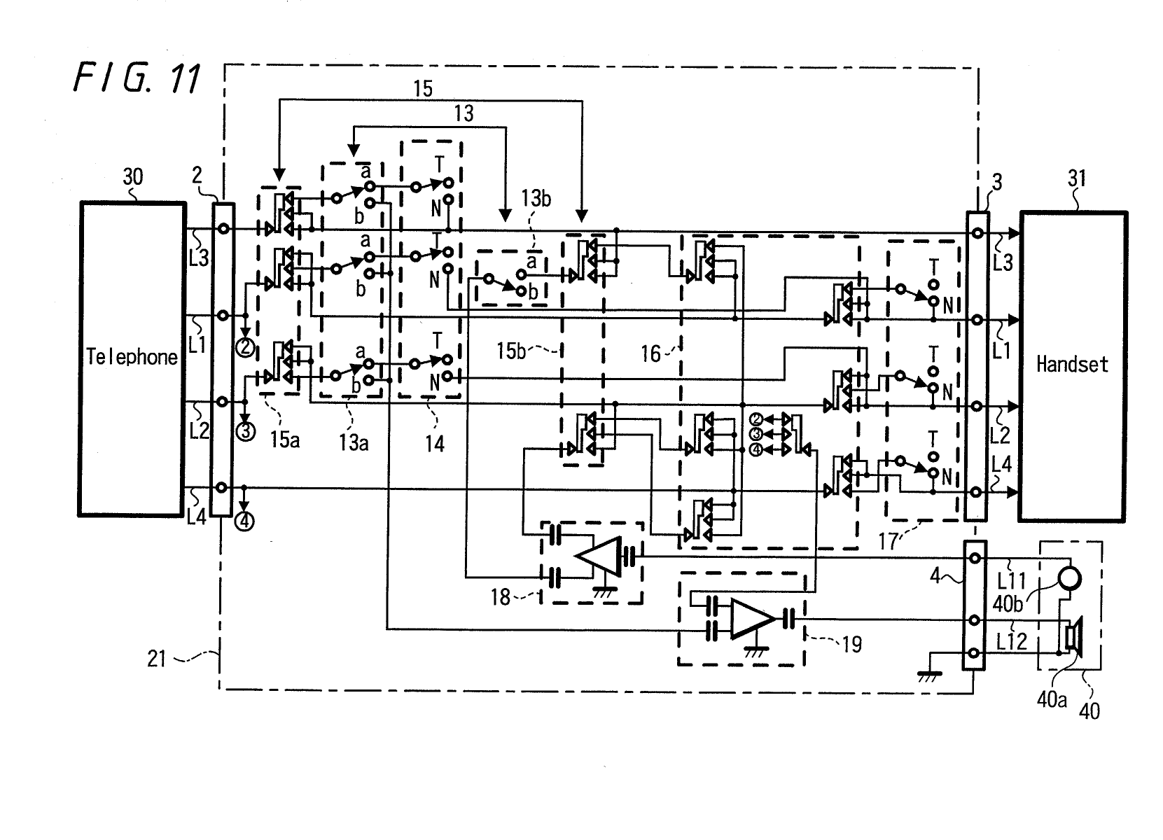

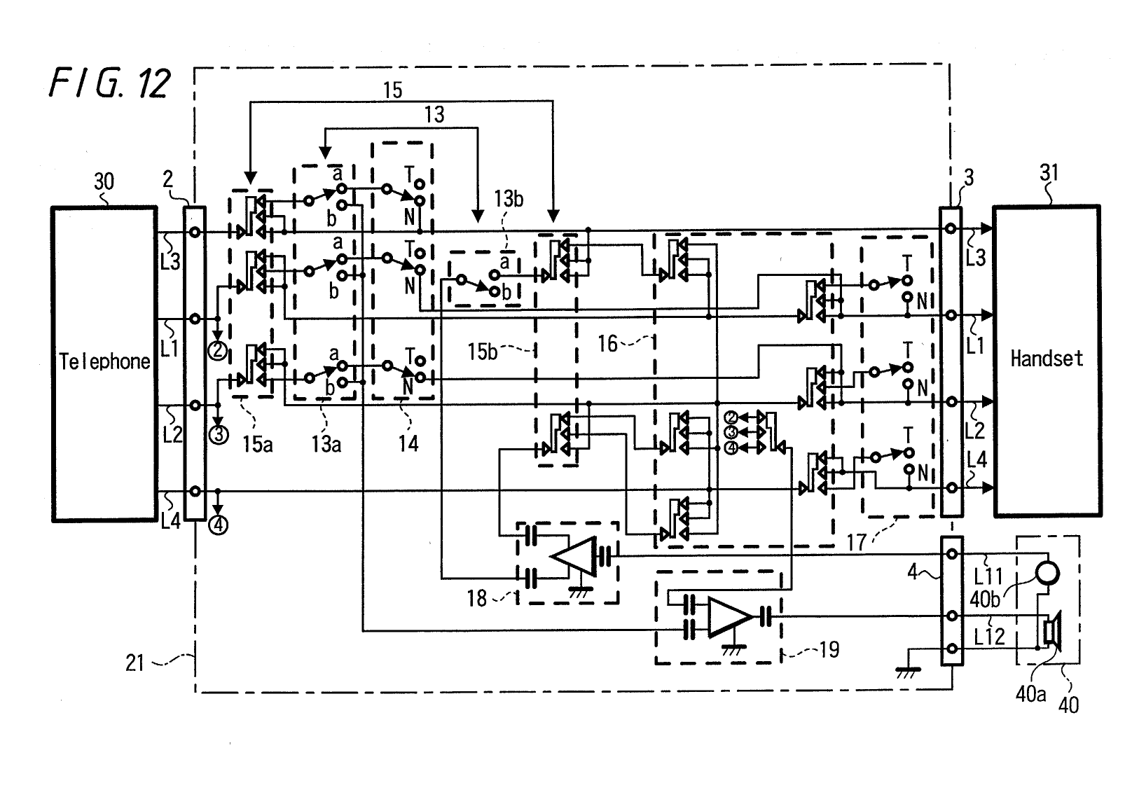

FIG. 9 is a diagram illustrating the constitution of the repeating device according to the second embodiment. In FIG. 9, and in FIGS. 11 and 12 that will be referred to later, numerals \mathring{2}, \mathring{3} and \mathring{4} represent the same paths.

The connection selection switches 13 (13a, 13b) are for selecting either the handset 31 or the headset 40 by the telephone 30 in the repeating device 21 like the connection selection switch 5 shown in FIG. 1. The connection selection switches 13a and 13b are interlocked together to change over the connection of contacts.

Test switches 14 and 17 are for selecting a normal mode and a test mode for searching for a state where the telephone 30 is correctly wired to the headset 40, i.e., where the voice outputted from the telephone 30 is not supplied to the handset 31. In these test switches 14 and 17, contacts T correspond to the test mode and the contacts N correspond to the normal mode.

The connection path selection switches 15 (15a, 15b) and the connection path selection switch 16 are constituted in the form of, for example, three-contact slide switches, and work to select the connection paths like the connection path selection switches 7 and 8 in the repeating device 21 described with reference to FIG. 1. That is, the state of connection can be selected depending upon the position of the conductor 35 as described with reference to FIG. 16. In the connection path selection switches 15 (15a, 15b) and 16, the connections by the respective conductors 35 are changed over by being interlocked together.

The amplifier unit 18 is connected to the connection path selection switch 15 and to the connection selection switch 13b to amplify the voice signals fed from the microphone unit 40b in the handset 40b. The amplifier unit 19 is connected to the connection selection switch 13a and to the connection path selection switch 16 to amplify the voice signals fed to the speaker unit 40a in the handset 40.

In a state where no voice signal is fed to the amplifier unit 19 in the test mode in the thus constituted repeating device 21, the insulated conductor that has been cut is used as the one that is made to correspond to the speaker unit in the handset 31. Therefore, a state where the telephone 30 is correctly connected to the headset 40 is established upon forming a wiring path similar to that of the handset 31 even for the headset 40.

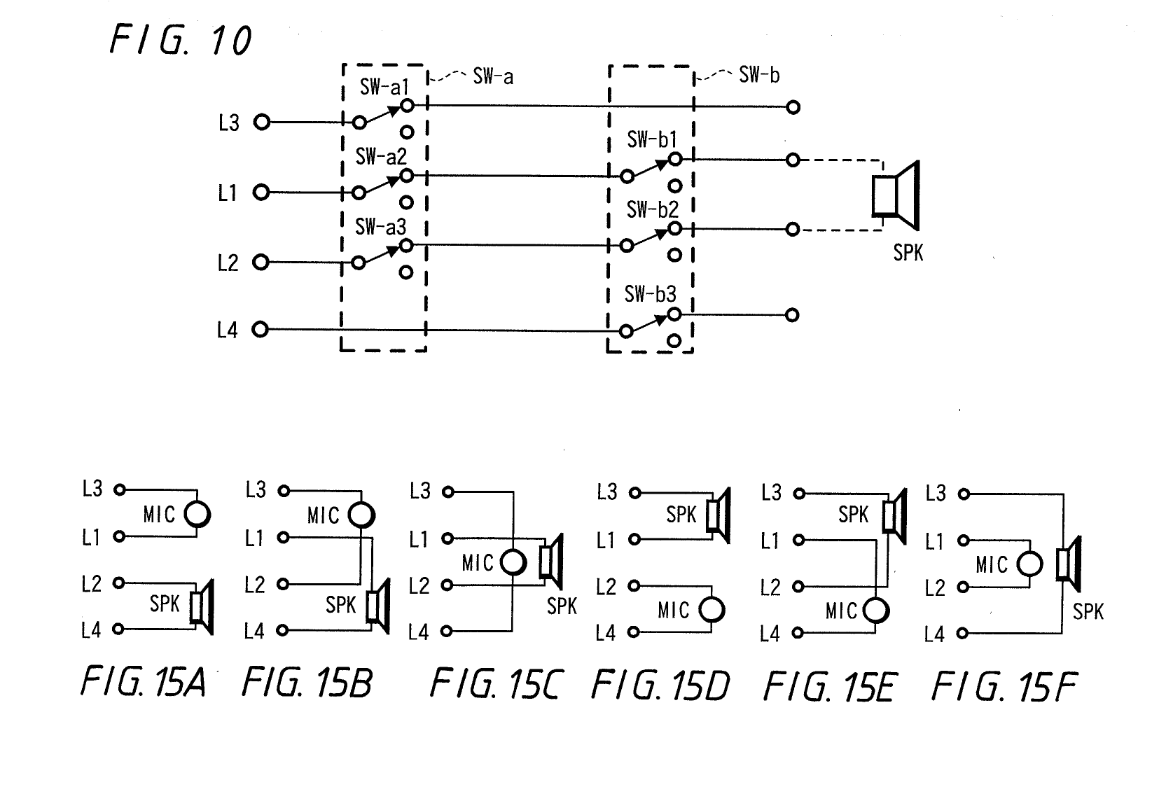

FIG. 10 is a diagram schematically and equivalently illustrating a state where the connection path selection switches 15 (15a, 15b) and the connection path selection switch 16 are connected in the test mode. It is presumed in this diagram that the switch SW-a corresponds to the test switch 14 and the connection path selection switch 15, and the switch SW-b corresponds to the connection path selection switch 16 and the test switch 17.

In describing with reference to FIG. 10, the second embodiment is to search for the state of connection where the voice of the telephone 30 is not heard from the speaker of the handset 40 by changing over the switches SW-a and SW-b and by cutting the insulated conductors connecting the telephone 30 to the handset 31 one by one. FIG. 10 illustrates a state where all insulated conductors have been connected in the switches SW-a and SW-b.

First, the connections of the repeating portions SW-a1, SW-a2 and SW-a3 constituting the switch SW-a are successively cut one by one to search for a state of connection where the voice of the telephone 30 is not heard from the speaker unit of the handset 31. When the connection state is found in the switch SW-a where no voice is heard, the connections of the repeating portions of the switch SW-a are returned back to the diagramed state. Then, the connections of the repeating portions SW-b1, SW-b2 and SW-b3 constituting the switch SW-b are cut one by one in order to search for a state of connection where no voice is heard from the telephone like in the case of the switch SW-a.

In changing over the switches SW-a and SW-b as described above, it happens that no voice is heard from the speaker unit of the handset 31, manifesting that the insulated conductor corresponding to the speaker unit is cut. In a state where no voice is heard from the speaker unit, therefore, it can be regarded such that the insulated conductor that is cut is corresponding to the speaker unit. When the voice is heard from the speaker, therefore, it can be so regarded that the insulated conductor that is cut corresponds to the microphone unit but not to the speaker unit.

If a case is considered where the speaker unit is connected to the insulated conductors L1 and L2 as shown, no voice is outputted from the speaker unit in a state where the connections of the repeating portions SW-a2 and SW-b2 have been cut. That is, it can be regarded that the speaker unit is connected between the insulated conductors L1 and L2.

Namely, if replaced by the repeating device 21 of FIG. 9 by presuming that the insulated conductors L1 and L2 correspond to the speaker unit of the handset 31, then, there may be formed a connection path by which the insulated conductors L1 and L2 correspond to the insulated conductor L11, i.e., correspond to the wiring of the speaker unit 40a in the headset 40.

The connection selection switches 13 (13a, 13b) and the connection path selection switches 15 (15a, 15b) are separately diagramed for convenience. They, however, are constituted as the same switch.

Next, described below with reference to FIGS. 11 and 12 is a case where the wiring of the speaker unit in the handset 31 is made to correspond to the telephone 30 in the repeating device 21 shown in FIG. 9.

Referring, first, to FIG. 11, the connection selection switches 13 (13a, 13b) are connected to the side of the handset (side of the contacts a), and the test switch 14 is connected to the test mode side (side of the contacts T). Then, the connection path selection switches 15 (15a, 15b) are changed over in a manner as described with reference to FIGS. 16(a), 16(b) and 16(c) to search a state where no voice is heard from the speaker unit of the handset 31. In FIG. 11, the connection path selection switches 15 (15a, 15b) are changed over, so that the insulated conductor L3 is cut from the handset 31 but correspond to the speaker unit.

When a connection position where no voice is heard is learned upon changing over the connection path selection switches 15 (15a, 15b), the connection path selection switches 15 (15a, 15b) are left to stay in this state as shown in FIG. 12, the test switch 14 is connected to the side of the normal mode (side of the contacts N) and the test switch 17 is connected to the side of the test mode (side of the contacts T).

In FIG. 12, therefore, the connection path selection switch 16 is changed over to search for a state of connection where no voice is heard from the speaker unit. FIG. 12 illustrates a state where, for example, the insulated conductor L1 is cut. When it is presumed that no voice is heard from the speaker unit in this state, the insulated conductor L3 and the insulated conductor 11 can be so wired as to correspond to the speaker from FIGS. 11 and 12. As shown in FIG. 9, therefore, when the normal mode is selected by the test switches 14 and 17, and the headset 40 is selected by the connection selection switches 13 (13a, 13b), there is selected a state of connection where the insulated conductors L3 and L1 correspond to the insulated conductor L11 and are connected to the speaker unit 40a, and the insulated conductors L4 and L2 correspond to the insulted conductor L12 and are connected to the microphone unit 40b, enabling the telephone 30 to be correctly connected to the headset 40.

According to the second embodiment as described above, a state where no voice is heard is, first, selected out of three connection states in the connection path selection switches 15 (15a, 15b) as a first step in the test mode and, then, a state where no voice is heard is selected out of the three connection states in the connection path selection switch 16 as a second step. It is thus allowed to select a correct combination of wirings between the speaker unit and the insulated conductors out of the six combinations shown in FIGS. 15(a) to 15(f).

The connection path selection switches 15 and 16 share the constitution of the switches for detecting the wirings and for simultaneously forming a correct connection path for the headset 40 like the connection path selection switches 7, 8 and 12 described in the above first embodiment.

The constitution of the repeating device 21 according to the second embodiment is only an example, and the constitutions of the switches and the wiring paths in the device are in no way limited to those that are diagramed. For example, the connection path selection switches 15 (15a, 15b) and 16 shown as three-contact slide switches can be constituted as triplet push switches.

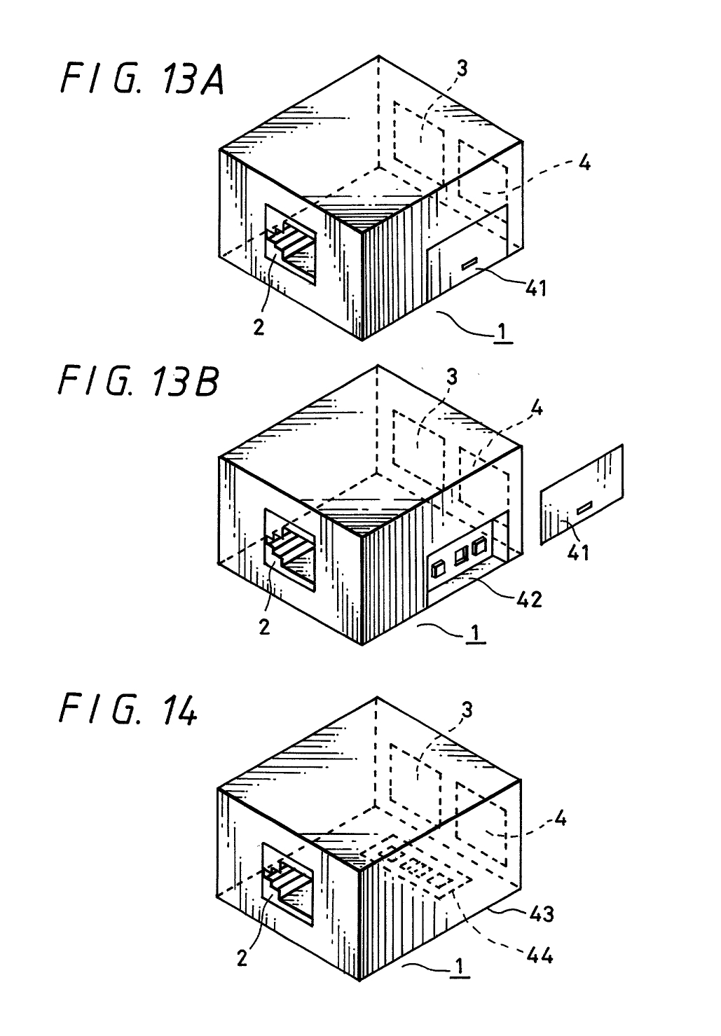

In the first and second embodiments, when the telephone is once correctly connected to the headset 40 which is an external device by the repeating device 1, 20 or 21, there is no need to change the state of connection until another kind of external device is connected thereto. When arranged at a required position in the practical use, therefore, the switches are concealed as shown in FIGS. 13(a), 13(b) and 14, in order to prevent the connection from being changed over that may results from the erroneous manipulation of the switches.

FIGS. 13(a) and 13(b) illustrate an example in which an operation portion 42 including knobs of various switches is formed in the side surface of the repeating device 1 (20, 21), and is concealed by a closure 41 that can be opened and closed, so that the knobs will not be touched by the user during the use.

FIG. 14 illustrates a state where the repeating device 1 (20, 21) is installed on a floor or on a wall. The operation portion 44 is formed in the installation surface of the repeating device 1, such as in the bottom surface 43 of the housing, so as to be concealed in a state in which the repeating device 1 is being installed without the need of providing the closure 41 that is shown in FIG. 13.

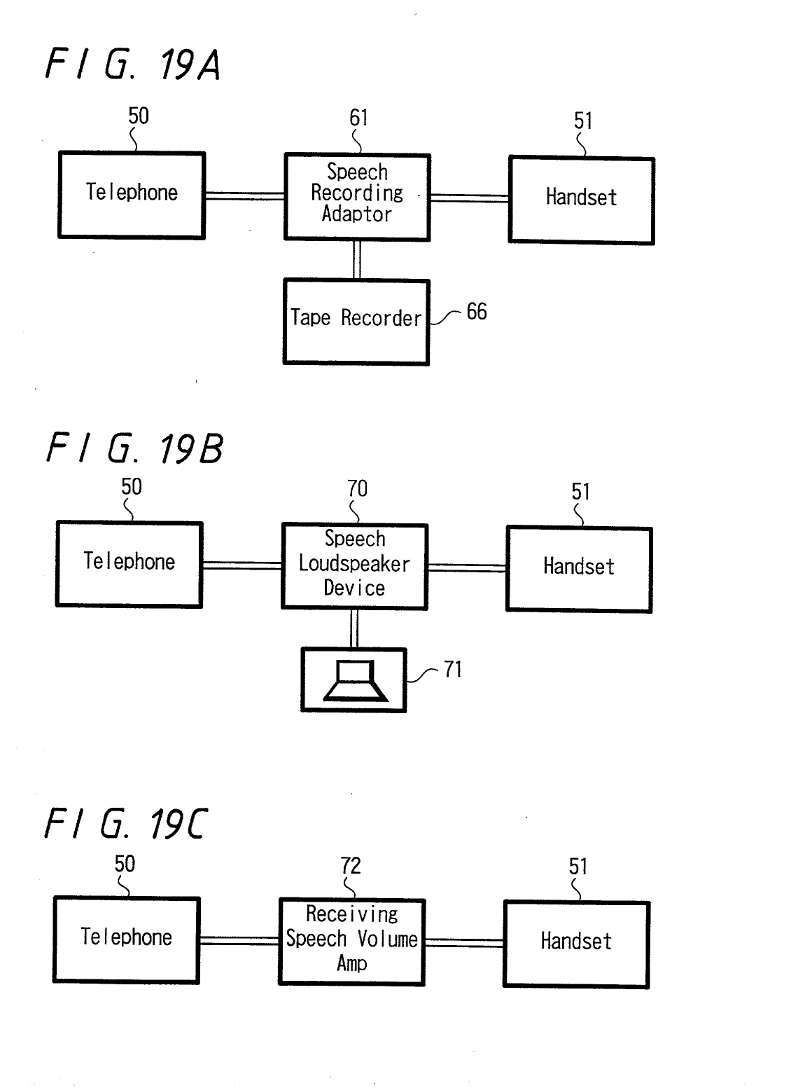

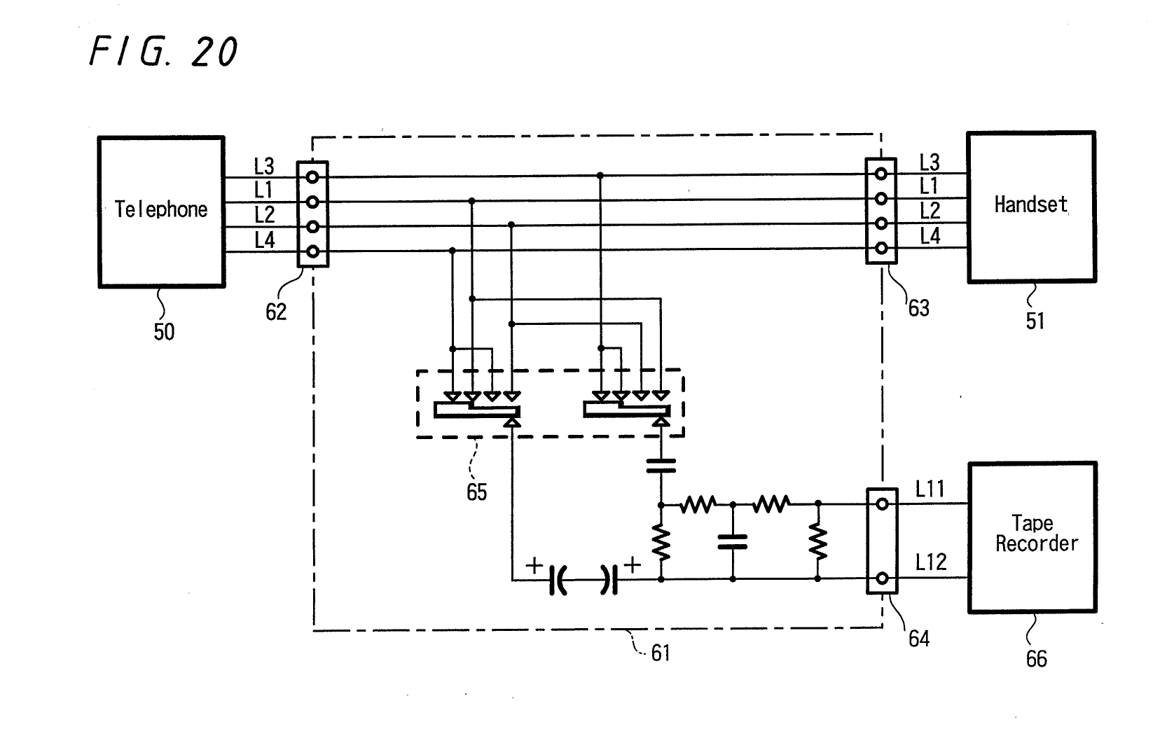

In the first and second embodiments, the external unit is, for example, a headset 40 and the repeating device 1 (21, 22) corresponds to the headset 40. However, the repeating device of the invention can also be applied to a speech recording adaptor 61 corresponding to the tape recorder 66 and to a speech loudspeaker device 70 corresponding to a speaker device 71 shown in FIG. 19. By using a receiving sound amplifier device 72 corresponding to the handset, further, the receiving sound can be amplified for the aged persons and for the persons who have difficulty of hearing. The repeating device of the invention is further useful for the cases where there is used a speaker telephone, a converter for converting voice signals into character data, or a modem.

Having described preferred embodiments of the present invention with reference to the accompanying drawings, it is to be understood that the present invention is not limited to the above-mentioned embodiments and that various changes and modifications can be effected therein by one skilled in the art without departing from the spirit or scope of the present invention as defined in the appended claims.

What is claimed is:

1. A repeating device having first and second connection terminal units for connecting a telephone and a handset together through a wire member having plural insulated conductors, and for relaying the connection between said telephone and said handset, said repeating device comprising:
a third connection terminal unit for connection to an external unit through a wire member having plural insulated conductors;
connection path selection means capable of selecting a connection path of said insulated conductors depending upon the kinds of the telephone and the handset; and
informing means for giving a required information when the wiring of said third connection terminal unit becomes the connection path of said insulated conductors corresponding to said telephone and said handset due to the selection by said connection path selection means.

2. A repeating device according to claim 1, wherein said informing means is constituted by an oscillator, and oscillation signals are fed to a speaker unit in said handset.

3. A repeating device according to claim 1, wherein said informing means gives information only when said connection path is selected by said connection path selection means.

4. A repeating device according to claim 1, wherein knobs of said connection path selection means are concealed.

5. A repeating device having first and second connection terminal units for connecting a telephone and a handset together through a wire member having plural insulated conductors, and for relaying the connection between said telephone and said handset, said repeating device comprising:
a third connection terminal unit for connection to an external unit through a wire member having plural insulated conductors; and
connection path selection means for successively cutting the connection of the insulated conductors connecting said telephone to said handset.

6. A repeating device according to claim 5, wherein knobs of said connection path selection means are concealed.
